(19) United States
(12) Patent Application Publication
(10) Pub. No.: US 2026/0347702 A1
(43) Pub. Date: Nov. 5, 2026

(54) TORREFACTION REACTOR SYSTEM

(71) Applicant: TORRGREEN TECHNOLOGY B.V., Amsterdam (NL)

(72) Inventor: Yash JOSHI, Mumbai (IN)

(73) Assignee: TORRGREEN TECHNOLOGY B.V., Amsterdam (NL)

(21) Appl. No.: 19/123,626

(22) PCT Filed: Oct. 27, 2023
(86) PCT No.: PCT/EP2023/080084

§ 371 Date: Apr. 23, 2025

(30) Foreign Application Priority Data
Oct. 28, 2022 (IN) 202211061471
Jan. 23, 2023 (NL) 2034003

(51) Int. Cl. C10B 57/14; C10B 53/02; C10B 57/10; C10L 5/44; C10L 9/08

(52) U.S. Cl. CPC C10B 57/14; C10B 53/02; C10B 57/10; C10L 5/442; C10L 9/083; C10L 2290/02; C10L 2290/06; C10L 2290/08

(57) ABSTRACT

The invention is directed to a torrefaction reactor system comprising three or more reactors and a sequence of stations comprising a discharge and loading station, a torrefaction station and a cooling station wherein each station is connected to a different reactor all connected to a reactor. The reactors are configured to disconnect from the discharge and loading station and torrefaction station and physically move to and connect to a next station in the sequence of stations and configured to disconnect from the cooling station and physically move to the discharge and loading station.

The invention is directed to a torrefaction reactor configuration comprising four or more reactors. The configuration further has means for discharging torrefied biomass and loading biomass feedstock, means for drying biomass feedstock, means for performing a torrefaction of dried biomass and means to cool the obtained torrefied biomass. The invention is further directed to a process to subject a biomass feed to torrefaction in the invented torrefaction reactor configuration.

Such a reactor system is described WO2020/245337. This publication describes a configuration of 8 batch reactors which are operated simultaneously in cycles of between 5 and 10 minutes. At one moment in time one batch reactor is being emptied from torrefied biomass and being filled with fresh biomass feed. At the same time two batch reactors filled with biomass feed in previous cycles are fluidly connected to drying gas system route which gas is directly contacted with the fresh biomass feed resulting in that the contents of the reactors are dried. Three batch reactors with dried biomass obtained in previous cycles are connected to a closed torrefaction gas route resulting in that the content of these reactors are torrefied. Two reactors with torrefied biomass obtained in previous cycles are connected to a closed cooling gas route to cool the contents of these reactors. In this configuration the biomass is not transported to a next reactor. Instead the process of filling, drying, torrefaction, cooling and emptying are performed in the same reactor. Such a reactor configuration is especially suited for fibrous biomass which is difficult to move from one reactor to the next reactor. The configuration requires that different gas routes are to be disconnected and connected to a reactor at the end of a cycle. In this publication a rotating valve is described which achieves this object. A problem with this configuration is the complex rotating valve.

The object of the present invention is to provide a torrefaction reactor configuration which is more simple than the prior art torrefaction reactor configuration.

This object is achieved by the following reactor system. Torrefaction reactor system comprising
three or more reactors wherein the reactors have a gas inlet opening, a gas outlet opening and a solids inlet opening and a solids outlet opening, and
a sequence of stations comprising a discharge and loading station, a torrefaction station and a cooling station wherein each station is connected to a different reactor such that
the discharge and loading station is connected to the solids inlet opening and to the solids outlet opening of at least one of the reactors,
the torrefaction station is fluidly connected to the gas inlet and the gas outlet of at least one of the reactors, and
the cooling station is fluidly connected to the gas inlet and the gas outlet of at least one of the reactors,
wherein the reactors are configured to disconnect from the discharge and loading station and torrefaction station and physically move to and connect to a next station in the sequence of stations and configured to disconnect from the cooling station and physically move to the discharge and loading station.

Applicants found that a rotating valve can be omitted from the system by physically moving the reactors from one station to the next station in the sequence of stations. The system allows for that emptying and filling a reactor, performing a torrefaction in another reactor and cooling torrefied biomass in a further different reactor can be performed simultaneously. Once a time has passed in that for example a sufficient torrefaction and/or cooling has taken place the reactors can be disconnected from their respective stations and physically moved to a next station.

The invention is therefore also directed to a process to subject a biomass to torrefaction as performed in a torrefaction reactor system as here described, by repeatedly performing actions (a), (c) and (d) simultaneously followed by performing action (e) wherein
action (a) comprises emptying a torrefied biomass from the at least one reactor connected the discharge and loading station to obtain an empty reactor and loading the biomass to an empty reactor, thereby obtaining loaded biomass,
action (c) comprises contacting a loaded biomass as present in the at least one reactor connected to the torrefaction station with an inert gas having a temperature of between 220 and 300 °C, thereby obtaining a torrefied biomass,
action (d) comprises contacting a torrefied biomass as present in the at least one reactor connected with a cooling gas having a temperature of between 10 and 100 °C thereby obtaining cooled torrefied biomass and
action (e) comprises
disconnecting one of the reactors or reactor from the discharge and loading station and physically move to and connect to the torrefaction station,
disconnecting one of the reactors or reactor from the torrefaction station and physically move to and connect to the cooling station, and
disconnecting one of the reactors or reactor from the cooling station and physically move to and connect to the discharge and loading station.

In the system of the invention a drying station may be omitted when the biomass feed is very dry having a water content of less than 5 wt %, preferably less than 3 wt %. When the biomass is not very dry it is preferred that the system comprises a drying station. Preferably in such a system at least four reactors are present and wherein the sequence of stations is comprised of the discharge and loading station, a drying station, the torrefaction station and the cooling station and wherein the drying station is fluidly connected to at least one of the reactors and wherein the at least one reactor is configured to disconnect from the drying station and move to and connect to a next station.

The system involving a drying station also allows for that emptying and filling a reactor, drying biomass in another reactor, performing a torrefaction in another further reactor and cooling torrefied biomass in another further different reactor can be performed simultaneously. Once a time has passed in that for example a sufficient drying, torrefaction and/or cooling has taken place the reactors can be disconnected from their respective stations and physically moved to a next station.

The invention is therefore also directed to a process to subject a biomass to torrefaction as performed in a torrefaction reactor system here described, by repeatedly performing actions (a)-(d) simultaneously followed by performing action (e) wherein:
action (a) comprises emptying a torrefied biomass from the at least one reactor connected the discharge and loading station to obtain an at least one empty reactor and loading the biomass to anthe at least one empty reactor thereby obtaining loaded biomass,
action (b) comprises contacting a loaded biomass as present in the at least one reactor connected to the drying station with air having a temperature of between 50 and 150 °C thereby obtaining used drying air and dried biomass,
action (c) comprises contacting a dried biomass as present in the at least one reactor connected to the torrefaction station with an inert gas having a temperature of between 220 and 300 °C, thereby obtaining a torrefied biomass and a gas,
action (d) comprises contacting a torrefied biomass as present in the at least one reactor connected to the cooling station with a cooling gas having a temperature of between 10 and 100 °C thereby obtaining cooled torrefied biomass and
action (e) comprises
disconnecting one of the reactors or reactor from the discharge and loading station and physically move to and connect to the drying station,
disconnecting one of the reactors or reactor from the drying station and physically move to and connect to the torrefaction station,
disconnecting one of the reactors or reactor from the torreafaction station and physically move to and connect to the cooling station, and
disconnecting one of the reactors or reactor from the cooling station and physically move to and connect to the discharge and loading station.

The system provides for that the reactors physically move from one station to the next station in the sequence of stations. The stations are physically apart such that an reactor can only connect to one station at a time. This movement may be any movement like a linear movement or a rotational movement. Preferably the reactors are configured to move on an endless rail system. This allows a linear movement of the reactors and may be beneficial because it enables one to create space, by lengthening the rail, for manual loading and discharging of the biomass and cooled torrefied biomass respectively. More preferably the reactors are tubular reactors having a reactor axis and mounted parallel with respect to each others reactor axis in a tubular plane having a tube axis of the tubular plane which runs parallel with the reactor axis's and wherein the reactors are configured to move around the tube axis of the tubular plane. The latter allows a rotational movement from one station to a next station and is preferred because it can be more compact as compared to the endless rail embodiment.

The reactors of the system or configuration may have any cross-sectional shape such as rectangular, hexagonal and circular. The reactor may be made from a drum, more preferably an adapted ISO steel drum and even more preferably the ISO steel drum, for example a Full Open Head (FOH) drum. Preferably circular resulting in a tubular reactor preferably having a tubular inner surface. The preferred tubular reactors are elongated reactors, preferably elongated tubular reactors have a length to internal diameter ratio of between 3 and 10 (m/m) and preferably 5 and 10 (m/m). Preferably the walls of the reactors are relatively thin metal walls which allow quick heating and cooling in the short cycle times of the process. In order to ensure enough mechanical integrity the external side of the tubular wall is suitably provided with reinforcement ribs. A layer of insulation may be present at the external side of the elongated tubular reactors.

The gas inlet opening is suitably present at one axial end of the reactor and the gas outlet opening is present at the opposite axial end of the reactor. The gas inlet opening and/or gas outlet opening may be a different opening or the same opening as the solids inlet opening and/or the solids outlet opening as will be described below.

The torrefaction reactor system may have a vertical orientation wherein the tube axis of a system having a rotational movement runs substantially vertical. Such a orientation is favoured when the reactor is used in a more industrial setting. For example when more than one of such reactor systems are operated in parallel. Emptying the formed torrefied biomass from the reactor can be easily performed using gravity and optionally enhanced by a plunger which may run through the reactor from above in action (a) only. The loading biomass may also be performed using gravity optionally enhanced by a plunger, preferably the same plunger used for unloading. Such a one or more parallel operated vertical reactor systems may be positioned on the same level of a multi level building or construction. Biomass may suitably supplied to the reactor system from a level above the level where the reactor systems are positioned. Torrefied biomass may suitably discharged to a level below the level where the reactor systems are positioned. A vertical orientation is also preferred when the reactors are configured to move on an endless rail system.

For smaller scale operations it may be beneficial that the torrefaction reactor system having a rotational movement has a horizontal orientation wherein the tube axis runs substantially horizontal. Such a system does not require a multi level construction or building as described above. The reactors will consequently move from a lower to an upper part of the reactor system and back again to the lower part when in use. The loading of biomass and emptying the reactor of torrefied biomass may be performed using a horizontal plunger. In such a system the reactor preferably has two axial ends which are open. Biomass enters at one end of the reactor and by means of a plunger is distributed along the length of the reactor. Emptying the torrefied biomass may be via the same opening at the axial end as through which the biomass was supplied to the reactor. Preferably the torrefied biomass is emptied via the opposite opening at the other axial end of the reactor. In this manner use can be made of the same plunger as descried earlier.

In all of the above reactor systems it is preferred that the opening at both axial ends are provided with a removable sieve. The sieves ensure that the biomass remains in the reactor when the reactor is connected to the drying station, torrefaction station and cooling station. When the reactor is connected to the discharge and loading station the sieve at the receiving opening may be removed when loading biomass and suitably both sieves may be removed when emptying or discharging the torrefied biomass to allow the plunger to enter the reactor.

The discharge and loading station suitably comprises a horizontally or vertically moveable plunger for a horizontal or vertical oriented reactor system respectively. More preferably a moveable driver of the discharge and loading station is configured to connect to the removable sieve at the biomass inlet of the reactor which is connected to said station end to form the moveable plunger.

Suitably the four or more reactors have an opening for receiving solids at one axial end and an axially extending and facing downward closable opening for discharge of solids having an open and closed position. Such an opening allows a quick and easy emptying of the reactor. When such reactors are used it is preferred that the discharge and loading station connects with the at least one reactor at the lower part of the reactor system. In this way emptying of the reactor can be done without that the other reactors obstruct such emptying.

The loading station for the horizontal or vertical orientation is preferably provided with an opening for solids which is fluidly connected to the opening at the one axial end of the reactor connected to the loading station. Via the opening in the loading station solids can be supplied to this opening at the one axial end of the reactor. The loading station is preferably further provided with a hopper and more preferably also with a compression space. The compression space is at one end fluidly connected to the hopper to receive solids and fluidly connected to the opening for solids of the loading station.

In the reactor system having the it is preferred that the opening at the biomass receiving axial end is provided with a removable sieve and that the opening at the opposite axial end is provided with a fixed sieve. The reactor is configured such that the removable sieve, the fixed sieve, the internal walls of the reactor and the closable opening for discharge of solids in its closed position fixate the solids within the reactor and allow a gas to flow from one end to the opposite end of the reactor via the gas permeable sieves. The gas flows through the reactor and directly contacts the biomass when the reactor is connected to the drying station, torrefaction station and cooling station when performing actions (b), (c) and (d) respectively.

For a tubular reactor the axially extending and facing downward closable opening for discharge of solids having an open and closed position preferably comprises one or more solids discharge doors which door can open and close and when the one or more doors are in their closed position a tubular inner wall results in the reactor. The door is suitably connected to the tubular wall of the reactor along an axially extending hinge provided with a gas tight seal and wherein the axially extending other end of the door forms a gas tight closure with another door or with the wall of the tubular reactor in case of a single door when the door is in its closed position. Preferably the door comprises of two axially extending doors.

The reactor system which does not involve a drying station may comprise of 3 to 11 reactors. Preferably one or two reactors are connected to the discharge and loading station, two or three reactors are connected to the torrefaction station and one, two or three reactors are connected to the cooling station. More preferred the reactor system comprises of 4 reactors wherein one reactor is connected to the discharge and loading station, two reactors are connected to the torrefaction station and one reactor is connected to the cooling station.

The reactor system may comprise of between 4 and 12 reactors. Preferably one or two reactors are connected to the discharge and loading station, one, two or three reactors are connected to the drying station, two or three reactors are connected to the torrefaction station and one, two or three reactors are connected to the cooling station. More preferably the reactor system comprises of 8 and more preferably 7 reactors wherein one reactor is connected to the discharge and loading station, two reactors are connected to the drying station, two reactors are connected to the torrefaction station and two reactors are connected to the cooling station. Even more preferred the reactor system comprises of 6 reactors wherein one reactor is connected to the discharge and loading station, two reactors are connected to the drying station, two reactors are connected to the torrefaction station and one reactor is connected to the cooling station. When eight reactors are used the extra reactor may be configured to be connected to any one station and preferably the drying station for very wet feeds or the torrefaction station for larger dimension biomass. The afore mentioned connection is when actions (a)-(d) of the process is performed. When action (e) is performed, ie when the reactors physically move to a next station, for example when the mounted reactors rotate around the tube axis of the tubular plane, the reactors are disconnected to the different stations.

The drying station suitably comprises an outlet for drying air fluidly connected to one axial end of the at least one reactor which is connected to the drying station and an inlet for used drying air fluidly connected to the at least one reactor which is connected to the drying station. The drying station may be further connected to an air drying gas route comprising an air heater and gas displacement means. Preferably the temperature of the air is increased by mixing the air with a flue gas and/or with a flare gas as will be described below. When two or more reactors are connected to the drying station it is preferred that the reactors are positioned in series with respect to the flow of drying air. Thus the outlet for drying air of an upstream reactor will then be fluidly connected to the inlet of a downstream reactor in the series.

The air supplied by the drying station in action (b) has a temperature of between 50 and 150 °C. The air may be heated by indirect heat exchange. In addition or instead of using indirect heat exchange the air may be mixed with inert gasses. Preferably the air comprises a flue gas. The flue gas is at least partly obtained by combustion of the gas obtained in action (c), which has a high caloric value. Combustion may take place for example in a flare and/or in a furnace. Further carbon dioxide may be added to lower the oxygen content.

The torrefaction station suitably comprises an outlet for inert torrefaction gas fluidly connected to one axial end of the at least one reactor which is connected to the torrefaction station and an inlet for used torrefaction gas connected to the at least one reactor which is connected to the torrefaction station. The torrefaction station is further connected to a torrefaction gas route comprising an inert gas heater and a gas displacement means. When two or more reactors are connected to the torrefaction station it is preferred that the reactors are positioned in series with respect to the flow of inert torrefaction gas. Thus the outlet for inert torrefaction gas of an upstream reactor will then be fluidly connected to the inlet of a downstream reactor in the series.

In action (c) biomass as present in the at least one reactor connected to the torrefaction station is contacted with an inert gas having a temperature of between 220 and 300 °C

In the above process the substantially inert gas in action (c) comprises less than 3 vol. % oxygen. The presence of oxygen is in practice almost unavoidable because some air may ingress the gas routes. Some oxygen may nevertheless be advantageous because it provides some in-situ exothermic heating within the torrefaction reactor. Preferably the substantially inert gas in action (c) comprises of the torrefaction gas obtained in action (c) or the combustion gasses obtained when combusting this torrefaction gas or mixtures thereof. Suitably the substantially inert gas flows in a torrefaction gas route comprising of a gas heater, a gas displacement means and the biomass holding space in the reactor or reactors. The substantially inert gas used in action (c) at start-up of the process suitably comprises of more than 50 vol % and preferably of more than 95% vol % carbon dioxide. In time the circulating gas will be comprised of hydrocarbons originating from the biomass resulting in a high caloric gas. This gas may be used in a furnace of the gas heater. Purge or excess high caloric gas is suitably combusted in a flare.

The air heater and the substantially inert gas heater are preferably one apparatus. The required heat is provided by combustion of the high caloric gas obtained in action (c). Preferably some additional fuel is used to comply to the total energy demand of the torrefaction process. This additional fuel may be any gaseous or solid fuel. Preferably some of the dried or torrefied biomass is used as this additional fuel. Such a heater in which torrefaction gas and dried or torrefied biomass is used as fuel may be for example be a moving grate incinerator. The air used in action (b) and the substantially inert gas used in action (c) is preferably heated up by indirect heat exchange against the combustion gasses obtained when combusting the torrefaction gas and dried or torrefied biomass in for example such a moving grate incinerator.

The cooling station comprises an outlet for cooled gas fluidly connected to one axial end of the at least one reactor which is connected to the cooling station and an inlet for used cooled gas connected to the at least one reactor which is connected to the cooling station and wherein the cooling station is further connected to a cooling gas route comprising a gas cooler and a gas displacement means. Cooling of the gas may be achieved by directly contacting with a water spray.

In cooling action (d) a torrefied biomass as present in the at least one reactor is cooled by directly contacting the torrefied biomass with a cooling gas having a temperature of between 10 and 100 °C thereby obtaining cooled torrefied biomass. The cooling gas may be flue gasses of the process, nitrogen, steam, carbon dioxide or air. Air may be present in admixture with an inert gas such as flue gasses of the process, steam and/or carbon dioxide. A mist of liquid water may be present in the air to enhance the cooling power of the cooling gas.

When two or more reactors are connected to the cooling station it is preferred that the reactors are positioned in series with respect to the flow of cooling gas. Thus the outlet for used cooling gas of an upstream reactor will then be fluidly connected to the inlet of a downstream reactor in the series.

The cooling gas will flow in a closed route over a heat exchanger where the gas is reduced in temperature by indirect heat exchange against a cooling medium. Preferably the cooling medium is ambient air. The gas route has a purge for used cooling gas to avoid build up of condensate. Fresh gas, preferably air, may be added to compensate for the purged gas.

Preferably cooling is performed in two stages, wherein in a first stage the torrefied biomass is reduced in temperature to a temperature of between 100 and 130 °C by directly contacting the torrefied biomass with a substantially inert gas to obtain a partially cooled torrefied biomass and in a second stage where the partially cooled torrefied biomass is further reduced in temperature by directly contacting the partially cooled torrefied biomass with the effluent, ie the used drying air, of the most downstream reactor connected to the drying station. Suitably the temperature of the cooled torrefied biomass obtained in cooling action (d) is ambient or near ambient. With near ambient is meant not more than 20 °C above ambient. The substantially inert gas may comprise nitrogen, steam and/or carbon dioxide, preferably reduced in temperature by adding a spray of liquid water to the stream of the substantially inert gas is contacted with the torrefied biomass.

The pressure at which actions (b), (c) and (d) are performed may be any pressure between ambient and 2 MPa. Preferably the pressure is between 0.1 and 0.25 MPa allowing the use of thinner walled reactors. Preferably the pressure within the reactors at which action (a) and (e) are performed is preferably ambient or around ambient.

The biomass used as feed to the above process or used in the above described batch reactors according to the invention or in the system according this invention may be any biomass which allows a certain gas flow from a gas inlet to a gas outlet through the mass of biomass. Such a gas flow is found to be achievable when the biomass has a bulk density of below 200 kg/m³ and preferably below 100 kg/m³. The biomass may be wood, like for example wood chips or pellets. Preferred sources of biomass are fibrous biomass like for example grasses, Miscanthus giganteus, also known as elephant grass, oil palm empty fruit bunch fiber (OPEFBF), coconut coir fiber (CCF), pineapple peel (PP), pineapple crown leaves (PCL), kenaf bast fiber (KBF), kenaf core fiber (KCF), sugarcane bagasse, sugarcane trash, straw, for example rice straw and/or wheat straw.

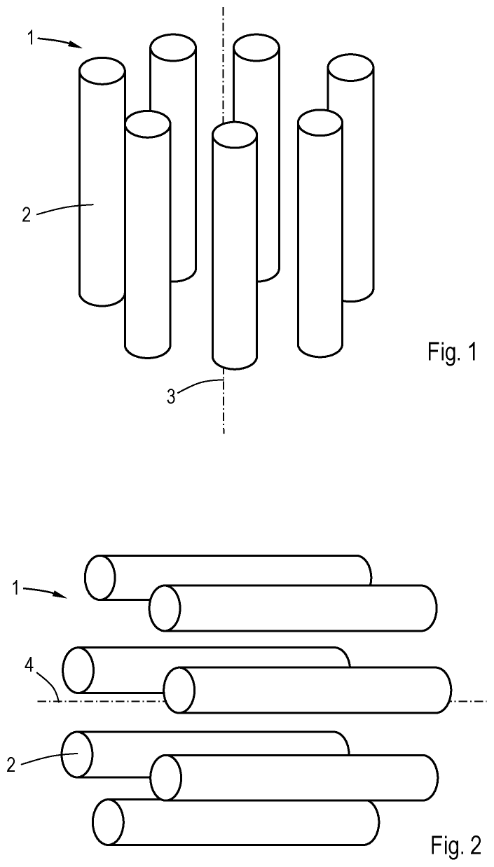

FIG. 1 shows part of a torrefaction reactor system (1) comprising seven elongated reactors (2) having a tubular design and mounted parallel with respect to each other. The elongated reactors (2) are mounted a tubular plane having a vertical tube axis (3).

FIG. 2 shows part of a torrefaction reactor system (1) comprising seven elongated reactors (2) mounted parallel with respect to each other. The elongated reactors (2) are mounted a tubular plane having a horizontal tube axis (4).

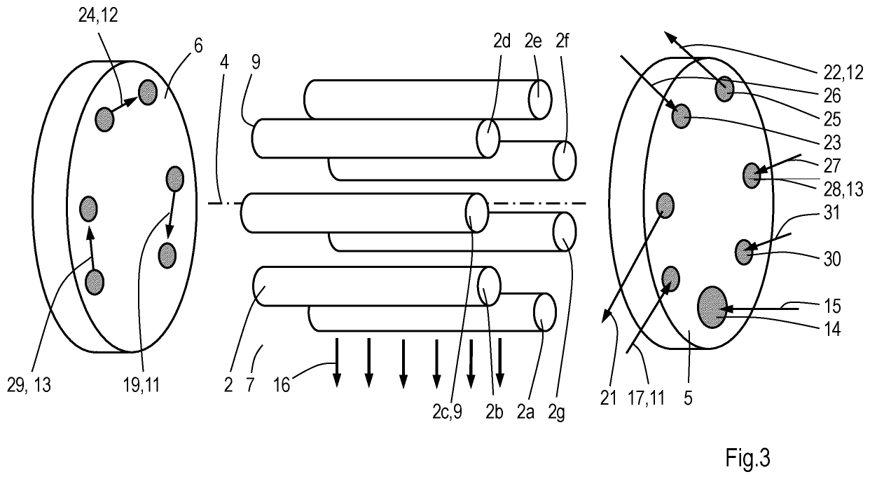

FIG. 3 shows the torrefaction reactor system (1) of FIG. 2 having horizontal tube axis (4). A front manifold (5) and a rear manifold (6) is shown spaced away from the elongated reactors (2) in a rotatable position (7). The front manifold (5) and the rear manifold (6) also have a working position (8) where the openings in the manifold fluidly connect with the open ends (9) of the elongated reactors (2). In the working position (8) one elongated reactor (2) in radial position (2a) is connected to a discharge and loading station (10), two elongated reactors (2) in radial positions (2b,2c) are connected to a drying station (11), two elongated reactor (2) in radial positions (2d,2e) are connected to a torrefaction station (12) and two elongated reactors (2) in radial positions (2f,2g) are connected to a cooling station (13). Radial positions (a-g) are consecutive radial positions along a circle starting with radial position (a) and ending at radial position (g).

The discharge and loading station (10) has an opening for solids (14) to which solids (15) indicated by the arrow may be supplied to load elongated reactor (2) in radial position (2a). Radial position (2a) is in the lower part of the reactor system (1). This allows torrefied biomass to be discharged along the length of the reactor (2) in radial position (2a) without that the reactors in the other radial positions obstruct such emptying. The discharged torrefied biomass is indicated by arrows (16).

The drying station (11) which connects with the elongated reactors (2) in radial positions (2b,2c) is provided with a supply conduit (17) for drying air connected via an opening (18) in front manifold (5) to the elongated reactor (2) in radial position (2b). The opposite open end of elongated reactor (2) in radial position (2b) is fluidly connected to a transfer conduit (19) as present in rear manifold (6) as part of the drying station (11). Transfer conduit (19) is fluidly connected to an open end of elongated reactor (2) in radial position (2c). The opposite end of elongated reactor (2) in radial position (2c) is fluidly connected via opening (20) in front manifold (5) to a discharge conduit (21) for used drying air as part of the drying station (11). In such a set up the elongated reactors (2) in radial positions (2b) and (2c) are positioned in series with respect to the flow of drying air.

The torrefaction station (12) which connects with the elongated reactors (2) in radial positions (2d,2e) is provided with a supply conduit (22) for inert torrefaction gas via an opening (23) in front manifold (5) to the elongated reactor (2) in radial position (2d). The opposite open end of elongated reactor (2) in radial position (2d) is fluidly connected to a transfer conduit (24) as present in rear manifold (6) as part of the torrefaction station (12). Transfer conduit (24) is fluidly connected to an open end of elongated reactor (2) in radial position (2e). The opposite end of elongated reactor (2) in radial position (2e) is fluidly connected via opening (25) in front manifold (5) to a discharge conduit (26) for used torrefaction gas as part of the torrefaction station (12). In such a set up the elongated reactors (2) in radial positions (2d) and (2e) are positioned in series with respect to the flow of inert torrefaction gas.

The cooling station (13) which connects with the elongated reactors (2) in radial positions (2f,2g) is provided with a supply conduit (27) for cooling gas connected via an opening (28) in front manifold (5) to the elongated reactor (2) in radial position (2f). The opposite open end of elongated reactor (2) in radial position (2f) is fluidly connected to a transfer conduit (29) as present in rear manifold (6) as part of the cooling station (13). Transfer conduit (29) is fluidly connected to an open end of elongated reactor (2) in radial position (2g). The opposite end of elongated reactor (2) in radial position (2g) is fluidly connected via opening (30) in front manifold (5) to a discharge conduit (31) for used cooling air as part of the cooling station (13). In such a set up the elongated reactors (2) in radial positions (2f) and (2g) are positioned in series with respect to the flow of cooling gas.

In action (e) of the process the disconnected mounted elongated reactors (2) in their rotatable position (7) can rotate around the tube axis (4) from one position to a next position, wherein the elongated reactor (2) in radial position (2a) moves to position (2b), the elongated reactor (2) in radial position (2b) moves to position (2c), the elongated reactor (2) in radial position (2c) moves to position (2d), the elongated reactor (2) in radial position (2d) moves to position (2e), the elongated reactor (2) in radial position (2e) moves to position (2f), the elongated reactor (2) in radial position (2f) moves to position (2g), and the elongated reactor (2) in radial position (2g) moves to position (2a). This is an example of how at least one elongated reactor which is connected to the discharge and loading station in a first position is connected to the drying system in a second next position, at least one elongated reactor which is connected to the drying station in the first position is connected to the torrefaction station in the second position, at least one elongated reactor which is connected to the torrefaction station in the first position is connected to the drying station in the second position and at least one elongated reactor which is connected to the drying station in the first position is connected to the discharge and loading station in the second position.

Such a rotational movement to a next position may be achieved in action (e) within a minute, preferably within 30 seconds. Once the elongated reactors are in their next position the front manifold (5) and the rear manifold (6) move axially towards the ends of the elongated reactors (2), or alternatively the elongated reactors move towards one of the manifolds which is fixed and the other manifold moves towards the ends of the elongated reactors (2), to achieve the working position (8). In this working position the openings in the manifold fluidly connect with the open ends (9) of the elongated reactors (2) resulting in that the different elongated reactors are connected to the different stations (10,11,12,13). When the reactor system is in its working position (8) a cycle can start wherein the different actions (a)-(d) are performed simultaneously. One cycle may performed within 5 to 20 minutes and preferably between 10 to 15 minutes.

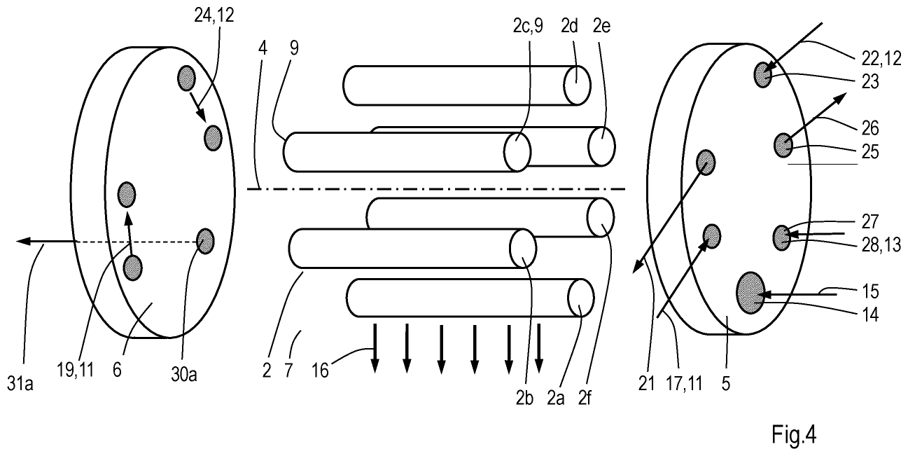

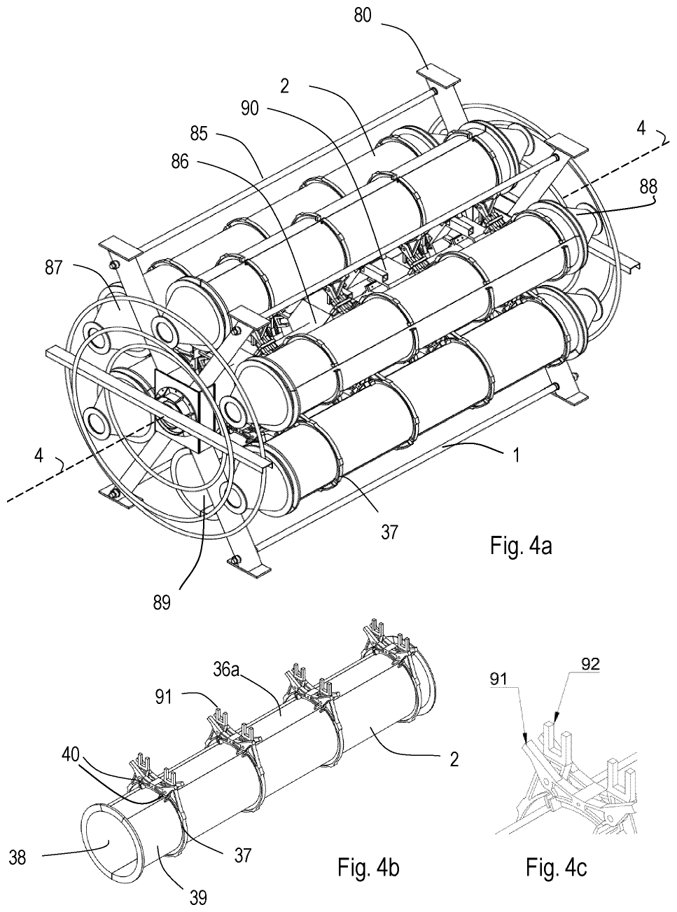

FIG. 4 is as FIG. 3 except that now only 6 elongated reactors (2) are part of the reactor system. The elongated reactors are in positions (2a-2f) as in FIG. 3. Thus position 2g is not present in FIG. 4. As a result no transfer conduit (29) is present in rear manifold (6). Instead the opposite end of elongated reactor (2) in radial position (2f) is fluidly connected via opening (30a) in rear manifold (6) to a discharge conduit (31a).

FIG. 4a shows part of the reactor system of FIG. 4 in more detail. Two vertically disposed, X-shaped frames (80) separated by a finite distance connected by tie-rods (85) support an axle (86) along axis (4). The 6 elongated reactors (2) are connected to the axle (86) via a frame (90) such that the reactors can rotate along the axis (4). The converging parts (87) are part of the static front manifold (5) and the converging parts (88) are part of the static rear manifold (6) and cannot rotate. The discharge and loading station (not shown) can load biomass to elongated reactor (89) in the lower part of the reactor system (1). No converging part (87) is present in this lower positioned reactor thereby allowing biomass to be fed into this reactor (89). The elongated reactors have a tubular wall (36), which may be made from relatively thin metal sheet, and is provided at its external side with reinforcement ribs (37).

FIG. 4b shows a single reactor (2) of FIG. 4a provided with two doors (38,39) in their closed position which each are connected to a tubular wall part (36a) by four pairs of hinges (40). The two doors (38,39) and the tubular wall part (36a) form the tubular wall (36). The hinge (40) extends into reinforcement ribs (37) to provide mechanical integrity to the two doors (38,39) during opening and closure.

FIG. 4c shows a detail of a hinge (40) of FIG. 4b. Hinge (40) is connected to frame (90) of FIG. 4a by connectors (91). The slotted appendages (92) interface with the screw-jack mechanism, responsible for opening and closing the doors (not shown in figure).

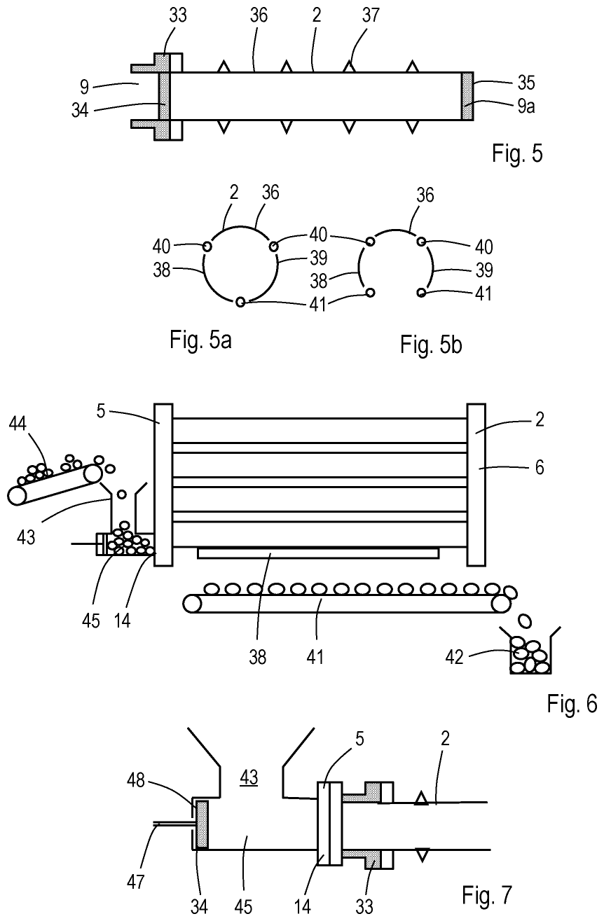

FIG. 5 shows an elongated reactor (2) suited for the reactor system of FIGS. 3, 4 and 4a. At one end (9) of the elongated reactor (2) a machined part (33) and a removable sieve (34) is shown. The removable sieve (33) can be fixed into the machined part (33) by a rotating connection, such as a bayonet connection. The sieve (34) is removable such to allow loading of biomass when the elongated reactor (2) is connected to the discharge and loading station (10). At the rear end (9a) of the elongated reactor (2) a fixed sieve (35) is shown. When performing actions (a)-(d) of the process of this invention these sieves (34,35) allow gas to pass and directly contact the biomass in the elongated reactor while the biomass is contained within the elongated reactor (2). A tubular wall (36), which may be made from relatively thin metal sheet, is provided at its external side with reinforcement ribs (37).

FIGS. 5a and 5b show a very schematic cross-sectional view of the elongated reactor (2) of FIG. 4b. In FIG. 5a shows the reactor provided with two doors (38,39) in their closed position which are connected to the tubular wall part (36) by a axially extending hinge (40) provided with a gas tight seal. Where the doors meet another seal (41) is present to achieve a gas tight enclosure for the biomass when actions (b)-(d) of the process are performed in consecutive cycles. In FIG. 5a the doors (38,39) are in their open position. In this open position torrefied biomass as obtained in the previous consecutive cycles is discharged from the reactor by action of gravity in action (a).

FIG. 6 shows the reactor system of FIG. 3 and provided with elongated reactors (2) of FIGS. 4, 5a and 5b. The gas supply and discharge conduits of the different gas routes are not shown. The system is in its working position (8) wherein the doors (38,39) of the elongated reactor (2) in radial position (2a) are open to discharge torrefied biomass in action (a) to a lower located moving belt (41) which transports the torrefied biomass to a storage vessel (42) for torrefied biomass product. Fresh biomass is provided to a hopper (43) by a moving belt (44). A vertical moving plunger (46) compresses the biomass as supplied by the moving belt (44) in hopper (43) to a compression space (45) at the lower end of the hopper (43). Compression space (45) is fluidly connected to opening for solids (14) in front manifold (5). Once the torrefied biomass is discharged from the elongated reactor the doors (38,39) will be closed and fresh biomass is loaded in the elongated from this compression space (45). Discharging and loading is suitably performed within one cycle.

FIG. 7 shows part of elongated reactor (2) of FIG. 5 connected to opening (14) in front manifold (5) as in FIG. 6. The removable sieve (34) is disconnected from the elongated reactor (2) and connected to a horizontally moveable driver (47) to form a horizontally moveable plunger (48). This plunger (48) can push the compressed biomass as present in compression space (45) into the elongated reactor (2). This may be repeated until the reactor is filled with biomass.

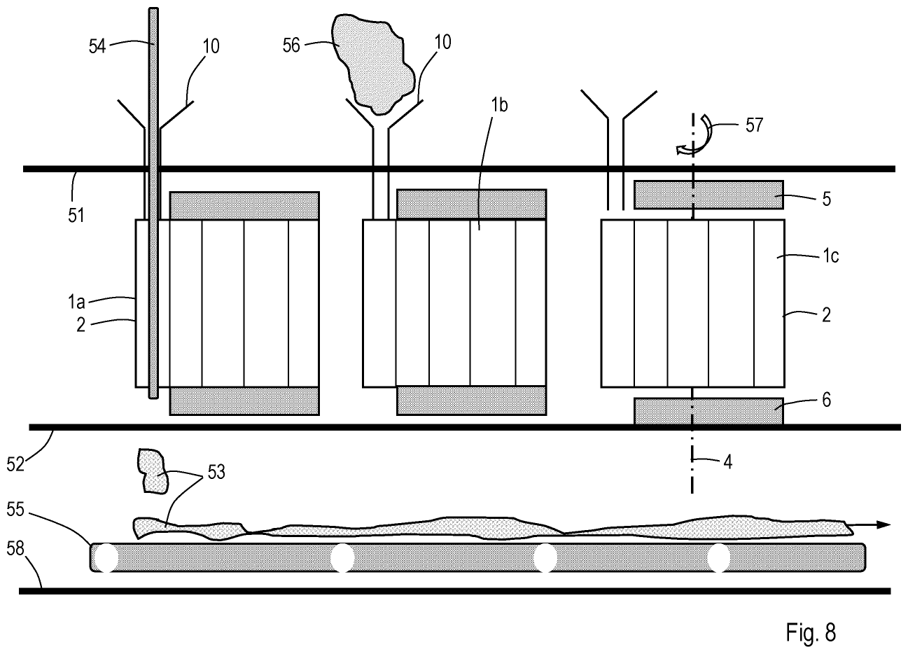

FIG. 8 shows three parallel operated reactor systems (1a, 1b, 1c) wherein the elongated reactors (2) have a vertical tube axis. The reactor systems are placed between two floors (50,51). Reactor system (1a) is in its cycle wherein one reactor (2) is radial position (2a) as connected to a discharge and loading station (10). From this elongated reactor (2) torrefied biomass (53) is discharged by gravity and enhanced by a vertical plunger (54). The torrefied biomass (53) drops onto a moving belt (55) as present on ground floor (58).

Reactor system (1b) is in its cycle wherein one reactor (2) is radial position (2a) and is connected to a discharge and loading station (10). To this elongated reactor (2) fresh biomass (56) is supplied via a compression space (45).

Reactor system (1c) is between cycles wherein the front manifold (5) and the rear manifold (6) are spaced away from the elongated reactors (2). This allows a rotation of the reactors to a next position as indicated by arrow (57).

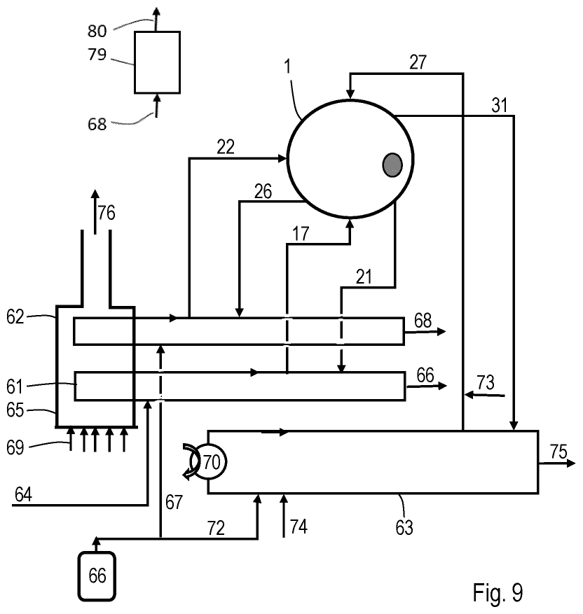

FIG. 9 shows schematically a drying gas route (61), torrefaction gas route (62) and cooling gas route (63) in relation to the reactor system (1). In the drying gas route, ambient air (64) is drawn in and heated in furnace (65). In furnace (65) a fuel (69) is combusted and a flue gas (76) is generated. The fuel, especially when starting the process, may be natural gas or lower hydrocarbon gases such as propane and/or butane. By indirect heat exchange the hot flue gas heats up the gas in both drying and torrefaction gas routes. The heated air flows in a closed route (62) back to furnace (65) as shown. Supply conduit (17) for drying air is fluidly connected to the drying gas route (61) and part of the drying air will flow via supply conduit (17) to the elongated reactors of the reactor system (1). From reactor system (1) humid air flow back to the drying gas route (61) via discharge conduit (21). As the humidity in the drying gas route (61) increases, the moist air is purged to the environment via a purge (66). During operation, the temperature of the drying air in conduit (17) is maintained at the highest possible temperature that the biomass can be safely dried without the risk of combustion. In practice, this temperature is found to be below 160 °C and preferably below 150 °C and above 140 °C.

A torrefaction gas route (62) is shown where inert gas is heated in furnace (65) and flows via closed route back to furnace (65). In the figure this is the same furnace as used for the drying gas route (61). This may also be separate furnaces. Supply conduit (22) for the inert gas is fluidly connected to the torrefaction gas route (62) and part of the inert gas will flow via supply conduit (22) to the elongated reactors of the reactor system (1). From reactor system (1) a gas richer in hydrocarbon volatiles returns via discharge conduit (26) to the torrefaction gas route (62). At the start-up, the torrefaction route (62) is preferably filled with CO₂ to a slight over pressure. The CO₂ is supplied from CO₂ storage vessel (66) and supply conduit (67) to the torrefaction gas route (62). During a cycle of the process the amount of hydrocarbon volatiles in the torrefaction gas route (62) increases as will the pressure. To avoid a too high pressure build up excess gas is purged from the torrefaction gas route (62) via purge (68). This high caloric gas is suitably used as fuel (69) in furnace (65) while the remaining high caloric gas of purge (68) is combusted in a flare (79) to obtain a flare flue gas (80). CO₂ does not necessarily have to be added after every cycle of the process. Once the torrefaction gas route is filled with inert gasses comprising for its majority the formed hydrocarbon volatiles no or only small amounts of CO₂ is required to be added.

A drying gas route (63) is shown where air is cooled in an indirect heat exchanger (70) and flows via closed loop back to heat exchanger (70). Supply conduit (27) for the cooling air is fluidly connected to the cooling gas route (63) and part of the air will flow via supply conduit (27) to the elongated reactors of the reactor system (1). From reactor system (1) a used cooling air returns via discharge conduit (31) to the cooling gas route (63). CO₂ may be supplied via conduit (72) to the cooling gas route (63) to dilute the air to reduce the risk of combustion of the torrefied biomass. Via an injection point liquid water (73) may be added to enhance the cooling power of the air by spraying the water (73) into the gas stream. Fresh air is supplied via supply (74). A purge (75) is present to avoid build up of unwanted compounds in the circulating gas.

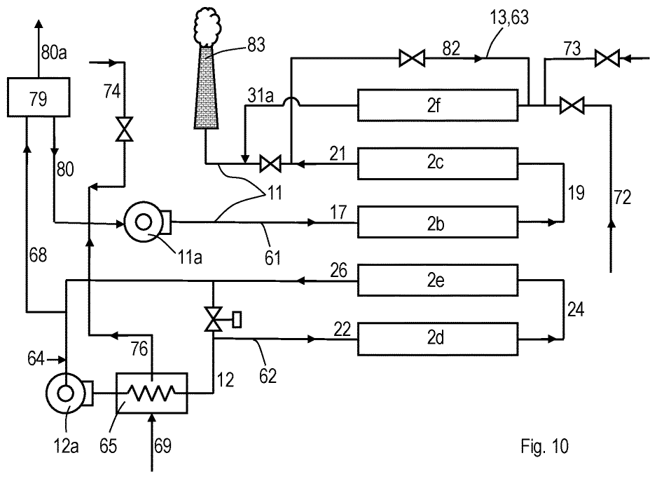

In FIG. 10 a more preferred scheme for the drying gas route (61), torrefaction gas route (62) and cooling gas route (63) in relation to the reactor system (1) is shown. The difference is that in furnace (65) only the inert gas of the torrefaction gas route (62) is heated in a closed loop. This closed loop is provided with a ventilator (12a). The reactors (2) are indicated by their position (2b-f) as illustrated in FIG. 4.

A drying gas route (63) is shown where the flue gas (76) from the main furnace (65) and the flare flue gas (80) is mixed with air (74) taken in from the ambient for controlling the temperature of the mixture so formed to less than 150 °C. This mixture will flow via supply conduit (17) to the elongated reactors of the reactor system (1) by means of a fan (11a).

Cooling is divided into two stages: a) high temperature cooling to cool the torrefied biomass from a high torrefaction temperature down to 120 °C and a low temperature cooling stage where the partially cooled biomass is cooled to about ambient temperatures. For the high temperature cooling, an inert cooling convective media, which may be H₂O, CO₂ and/or N₂) is supplied via conduit (72) route. Liquid water (73) is added to enhance the cooling power of the air. For the low temperature cooling, part or all of the used drying air as present in conduit (21) is routed via conduit (82) to the reactor (2) which is connected to the drying station (13) in position (2f).

Any excess flare flue gas (80) made in flare (79) is discharged to the environment as stream (80a). A chimney (83) is shown for discharge of used cooling gas as present in conduit (31a) and used drying air as present in conduit (21).

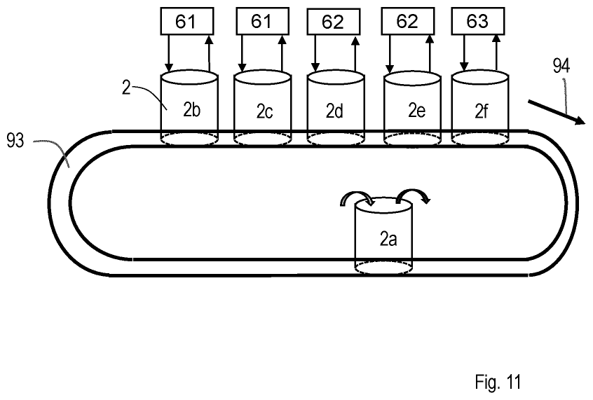

FIG. 11 shows a system wherein six elongated reactors (2) move on an endless rail system (93). Reactors (2) in position (2b) and (2c) are fluidly connected to drying gas loop (61) of FIG. 9 or 10. Reactors (2) in position (2d) and (2e) are fluidly connected to torrefaction gas loop (62) of FIG. 9 or 10. Reactor (2) in position (2f) is fluidly connected to cooling gas loop (63) of FIG. 9 or 10. Reactor (2) in position (2a) is being unloaded of cooled torrefied biomass and loaded with fresh biomass. In an action (e) all six reactors (2) move along the endless rail system (93) in the direction of arrow (94) where reactor (2) moves from position (2a) to position (2b), reactor (2) in position (2b) moves to position (2c), reactor (2) in position (2c) moves to position (2d), reactor (2) in position (2d) moves to position (2e), reactor (2) in position (2e) moves to position (2f) and reactor (2) in position (2f) moves to position (2a).

1. A torrefaction reactor system comprising
three or more reactors wherein each of the three or more reactors have:
a gas inlet opening,
a gas outlet opening,
a solids inlet opening, and
a solids outlet opening, and
a sequence of stations comprising:
a discharge and loading station,
a torrefaction station, and
a cooling station
wherein each station is connected to a different reactor of the three or more reactors such that:
the discharge and loading station is connected to the solids inlet opening and to the solids outlet opening of at least one of the three or more reactors,
the torrefaction station is fluidly connected to the gas inlet and the gas outlet of at least one of the three or more reactors, and
the cooling station is fluidly connected to the gas inlet and the gas outlet of at least one of the three or more reactors,
wherein the three or more reactors are configured to disconnect from the discharge and loading station and torrefaction station and physically move to and connect to a next station in the sequence of stations and configured to disconnect from the cooling station and physically move to the discharge and loading station.

2. The torrefaction reactor system according to claim 1,
wherein at least four reactors are present and
wherein the sequence of stations is comprised of the discharge and loading station, a drying station, the torrefaction station, and the cooling station and
wherein the drying station is fluidly connected to at least one of the at least four reactors and
wherein the at least one reactor is configured to disconnect from the drying station and move to and connect to a next station.

3. The torrefaction reactor system according to claim 1, wherein the reactors are configured to move on an endless rail system.

4. The torrefaction reactor system according to claim 1, wherein the three or more reactors are tubular reactors having a reactor axis and mounted parallel with respect to each others reactor axis in a tubular plane having a tube axis of the tubular plane which runs parallel with the reactor axis's; and
wherein the three or more reactors are configured to move around the tube axis of the tubular plane.

5. The torrefaction reactor system according to claim 4,
wherein the tube axis of the tubular plane runs substantially horizontal defining a lower and upper part of the reactor system; and
wherein the gas inlet opening is present at one axial end of each reactor and the gas outlet opening is present at the opposite axial end of each of the three or more reactors.

6. The torrefaction system according to claim 5, wherein the reactor which is connected with the discharge and loading station is positioned at the lower part of the reactor system; and
wherein the solids inlet opening of each of the three or more reactors is the same opening as the gas inlet opening and/or the gas outlet opening; and
wherein the solids outlet opening of each of the three or more reactors is an axially extending and facing downward closable opening having an open position and a closed position.

7. The torrefaction reactor according to claim 6, wherein
the solids inlet opening at the one axial end is provided with a removable sieve and an opposite axial end of the reactor is provided with a fixed sieve; and
wherein, in use, the removable sieve, the fixed sieve, the internal walls of the reactor, and the closable opening of the solids outlet opening in its closed position fixate the solids within the reactor and allow a gas to flow from one end to the opposite end of the reactor via the gas permeable sieves.

8. The torrefaction reactor system according to claim 6, wherein the discharge and loading station comprises a horizontally moveable driver and the removable sieve of the reactor connected to the discharge and loading station has an opening to connect to the horizontally moveable driver to form a horizontally moveable plunger.

9. The torrefaction reactor system according to claim 6, wherein the solids discharge opening is provided with one or more solids discharge doors which are configured to open and close.

10. The torrefaction reactor according to claim 9, wherein the one or more solids discharge doors comprise two axially extending doors.

11. The torrefaction reactor system according to claim 1, wherein the three or more reactors each have a tubular wall and wherein the length to internal diameter ratio of the tubular wall is between 3 and 10 (m/m).

12. The torrefaction reactor system according to claim 1, wherein the three or more reactors each have a tubular wall and wherein an external side of the tubular wall is provided with reinforcement ribs.

13. The torrefaction reactor system according to claim 2, wherein one or two reactors are connected to the discharge and loading station;
one, two or three reactors are connected to the drying station;
two or three reactors are connected to the torrefaction station; and
one, two, or three reactors are connected to the cooling station.

14. The torrefaction reactor system according to claim 13,
wherein one reactor is connected to the discharge and loading station;
two reactors are connected to the drying station;
two reactors are connected to the torrefaction station; and
two reactors are connected to the cooling station.

15. The torrefaction reactor system according to claim 1,
comprising four to eight reactors; and
wherein one or two reactors are connected to the discharge and loading station;
two or three reactors are connected to the torrefaction station; and
one, two, or three reactors are connected to the cooling station.

16. The torrefaction reactor system according to claim 8, wherein the loading station comprises:
a hopper,
a compression space having an opening to the hopper to receive solids, and
an outlet for solids which is fluidly connected to the opening at the one axial end of the reactor connected to the loading station.

17. The torrefaction reactor system according to claim 2, wherein the drying station comprises:
an outlet for drying air fluidly connected to one axial end of at least one the reactors which is connected to the drying station, and
an inlet for used drying air fluidly connected to at least one of the reactors which is connected to the drying station, and
wherein the drying station is further connected to an air drying gas route comprising an air heater and a gas displacement means.

18. The torrefaction reactor system according to claim 1, wherein the torrefaction station comprises:
an outlet for inert torrefaction gas fluidly connected to one axial end of at least one the reactors which is connected to the torrefaction station, and
an inlet for used torrefaction gas fluidly connected to one axial end of at least one of the reactors which is connected to the torrefaction station, and
wherein the torrefaction station is further connected to a torrefaction gas route comprising an inert gas heater and a gas displacement means.

19. The torrefaction reactor system according to claim 17, wherein the cooling station comprises:
an outlet for cooled gas fluidly connected to one axial end of at least one of the reactors or reactor which is connected to the cooling station, and
an inlet for used cooled gas fluidly connected to at least one axial end of at least one of the reactors or reactor which is connected to the cooling station, and
wherein the cooling station is further connected to a cooling gas route comprising a gas cooler and a gas displacement means.

20. A process to subject a biomass to torrefaction as performed in a torrefaction reactor system according to claim 1, by repeatedly performing actions (a), (c), and (d) simultaneously followed by performing action (e) wherein
action (a) comprises emptying a torrefied biomass from the at least one reactor connected the discharge and loading station to obtain an empty reactor and loading the biomass to an empty reactor, thereby obtaining loaded biomass,
action (c) comprises contacting a loaded biomass as present in the at least one reactor connected to the torrefaction station with an inert gas having a temperature of between 220 and 300 °C, thereby obtaining a torrefied biomass and a gas,
action (d) comprises contacting a torrefied biomass as present in the at least one reactor connected with a cooling gas having a temperature of between 10 and 100 °C thereby obtaining cooled torrefied biomass and
action (e) comprises
disconnecting one of the reactors or reactor from the discharge and loading station and physically move to and connect to the torrefaction station,
disconnecting one of the reactors or reactor from the torrefaction station and physically move to and connect to the cooling station, and
disconnecting one of the reactors or reactor from the cooling station and physically move to and connect to the discharge and loading station.

21-29. (canceled)

30. The torrefaction reaction system according to claim 4, wherein the tube axis of the tubular plane runs substantially vertical.
